(19) United States
(12) Patent Application Publication
(10) Pub. No.: US 2009/0113296 A1
(43) Pub. Date: Apr. 30, 2009

(54) DISPLAYING A MAP AND ASSOCIATED SYMBOLIC CONTEXT INFORMATION

(75) Inventors: Andrea L. Klein Lacy, Mountain View, CA (US); Anne K. Sullivan, San Francisco, CA (US); Lisa J. Stifelman, Palo Alto, CA (US)

Correspondence Address: PERKINS COIE LLP/MSFT, P. O. BOX 1247, SEATTLE, WA, 98111-1247, US

(73) Assignee: Microsoft Corporation, Redmond, WA (US)

(21) Appl. No.: 11/925,683

(22) Filed: Oct. 26, 2007

(51) Int. Cl. G06F 3/00

(52) U.S. Cl. 715/700

(57) ABSTRACT

A map of a destination and its immediate surroundings are displayed at a relatively low level. Symbolic context information is displayed simultaneously, in order to provide a higher-level context for the location. The symbolic context information can include such things as nearby highways, exits, bridges, sports venues or other landmarks and points of interest. The symbolic context information can be displayed, for example, on the perimeter of the map, or on the map in a distinct visual style such as a different color or font or fish-eye view. As the map is updated, (for example if the user zooms in or out), the context information is updated as well. The context information can be interactive, and can display the relationship between the context item and the location being mapped.

### BACKGROUND

When viewing a map on a computer screen, users often want to see two levels of detail simultaneously. In order to travel to a specific address or other location, the user often wants to see a “zoomed-in” view showing the specific streets and intersections in the immediate proximity of the destination. At the same time, the user wants to see a “zoomed-out” view, showing where on a larger map the destination area is located. For example, the user might want to see a low-level map showing each individual street near the address, and a higher-level map of the city showing where in the city the destination is located.

Sometimes a split screen showing two separate maps, as illustrated in FIG. 1A provides this dual view functionality. Another option is show a blow up of a small area on top of a zoomed-out view (as is also done with traditional, paper maps), as FIG. 1B illustrates. Either way, the assumption is typically that the lower-level view should take precedence, because users need the most detail for the streets in close proximity to the destination. The zoomed-out view is abstractly represented to provide supplementary context.

Both of these strategies involve showing two maps simultaneously, each at a different level of resolution. Both of these solutions work reasonably well on computers with full size screens, because these screens are large enough to show two maps at once. However, users often need to view maps when they are away from their primary computer (e.g., in the car). In such situations, users may only have access to a portable device, such as a cell phone or personal digital assistant. These portable computing devices have viewing areas (e.g., screens) of very limited size, and thus are generally too small to display two maps simultaneously at a viewable resolution.

Services such as Google Local Mobile and Infospace offer maps for display on mobile phones. However, because of the small available display area, these maps typically show a mid-range view that is neither zoomed-in enough to see the relevant cross streets around one's destination, nor zoomed-out enough to see the context of one's destination (e.g., nearby major highways). With these mid-level mapping systems, most users find they need to either zoom-in or zoom-out immediately upon downloading the map. Continually zooming in and out on a portable device is inconvenient, slow, distracting, and hard to process cognitively.

### SUMMARY

A mapping system is provided that displays a map of a destination and its immediate surroundings at a relatively low level. The mapping system displays symbolic context information simultaneously to provide a higher-level context for the location by symbolically referencing context information that may be geographically beyond the perimeter of the displayed map. The symbolic context information can include such things as nearby highways, exits, bridges, sports venues, restaurants, gas stations, groups of restaurants/gas stations, or other landmarks and points of interest. The symbolic context information may also include the location of people or places related to calendar events, or other personally meaningful data. The mapping system can display the symbolic context information, for example, on the perimeter of the map, or on the map in a distinct visual style such as in a different color or font or with a fisheye view. As a user requests updates to the map, the mapping system updates the context information as well.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

FIGS. 1A and 1B illustrate prior art dual-view maps.

FIG. 2 is a block diagram illustrating a system for displaying maps of locations in a limited viewing area, according to some embodiments of the present invention.

FIG. 3 illustrates the simultaneous display of a map and symbolic context information concerning the mapped location, according to one embodiment of the present invention.

FIG. 4 is a flowchart illustrating steps for displaying directions from a location represented by symbolic context information to a destination, according to some embodiments of the present invention.

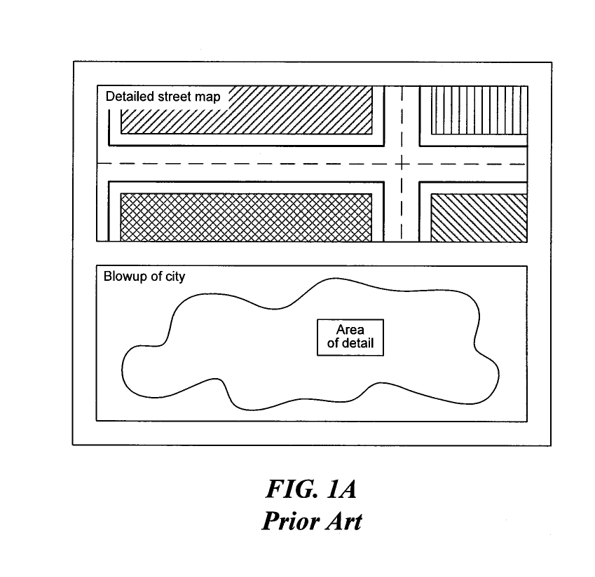

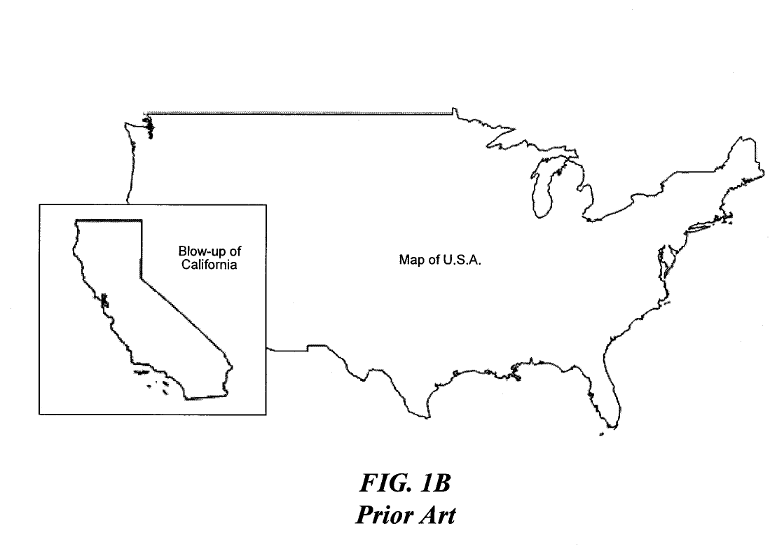

### DETAILED DESCRIPTION

### Overview

A mapping system is provided that displays a map of a destination and its immediate surroundings at a relatively low level. The mapping system displays symbolic context information simultaneously to provide a higher-level context for the location. For example, the mapping system may display a map in the middle of a viewing area, and the symbolic context information at the edges of the viewing area to reference entities that may be beyond the perimeter of the displayed map. The symbolic context information can include map entities, such as nearby highways, exits, bridges, sports venues, transit locations, scenic highways, points of interest, or other landmarks that may be represented on a map. Further, symbolic context information may include personal contact or calendar event locations, user-identified locations like home or work, business listings such as food, gas or lodging information, and so forth. For example, the symbolic context information may inform the user that a restaurant (or group of restaurants) is near the user's destination. The mapping system can display the symbolic context information in many different ways. For example, the mapping system can display the symbolic context information on the perimeter of the map or on the map in a distinct visual style, such as in a different color or font or with a fisheye view. In some embodiments, as a user requests updates to the map, the mapping system updates the context information as well. In this way, the mapping system provides the user with multiple levels of information in a limited viewing area.

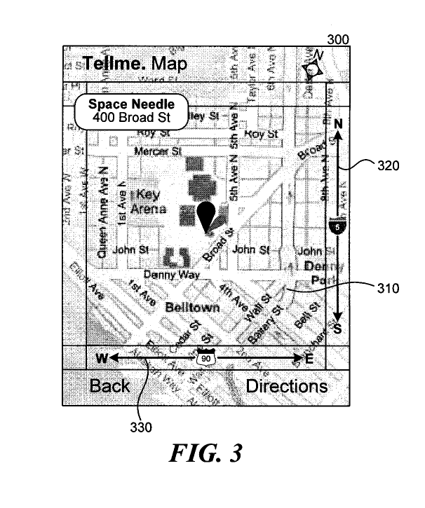

The symbolic context information can be a symbolic representation of any type of contextual data, displayed to put the low-level map view in a broader context. For example, the symbolic context information can be displayed in the form of icons, graphics, and/or text, representing such contextual reference points as highways, specific exits, bridges, etc. The symbolic context information can be displayed, for example, on the periphery of the map (as illustrated in FIG. 3). Alternatively, the symbolic context information could be displayed as an overlay to the map or on the map in a distinct visual style, such as a different font or color. Of course, other options for simultaneously displaying the map and corresponding symbolic context information are possible and within the scope of the present invention.

In some embodiments, the mapping system comprises a mobile device having a limited viewing area, such as a mobile phone, and an application server that provides map data and symbolic context information. A map-viewing component running on the mobile device transmits requests for maps of a location (e.g., a venue, a business, an address, etc.) to the application server. For example, the application server may be a website accessible using the Hypertext Transport Protocol (HTTP). The transmission of the request (as well as subsequently described communications between devices and components) can be made according to any transmission protocol, various examples of which are known to those of ordinary skill in the relevant art. The implementation mechanics of executing such transmissions within the context of the present invention will be readily apparent to those of such a skill level in light of this specification. The application server responds to the request by providing a map of the location and associated symbolic context information related to the location. The mobile device then displays the map of the location and the associated symbolic context information simultaneously.

In some embodiments, the application server requests and receives map data from a separate map server. For example, a provider of a website (e.g., Microsoft Virtual Earth) may obtain map data from a well-known map provider (e.g., Navteq). When the application server receives a request for a map, the application server forwards the request to the map server to obtain the map data. The map data corresponds to a map of the location at a desired level of detail. For example, if the user requests a map of a state, then the map data includes a map of the state zoomed out to a reasonable level that shows major geographic, political, or other features of the state. Alternatively or additional, the map and location data may be stored within a local computer system's storage or read from a disk or removable storage device.

In some embodiments, the mapping system obtains context data related to the map data. The context data can be any information providing a higher-level context to the mapped location. For example, proximate highways, exit numbers, parking lots, bridges, monuments, landmarks, cities, airports, restaurants, gas stations, lodging, transit centers, locations of people or events, user-generated content (such as favorite businesses or geocaches related to an outdoor treasure-hunting game in which the participants use a Global Positioning System (GPS) receiver or other navigational techniques to hide and seek containers called “geocaches” anywhere in the world), and other points of interest are all examples of possible contextual data. The mapping system may obtain the context data from the map server or from a separate provider of context data. For example, many websites on the Internet provide lists of points of interest related to various locations.

In some embodiments, the application server queries a listings database to obtain any additional information (e.g., a specific address) needed to obtain a map and context data related to the location. Those of ordinary skill in the relevant art know the mechanics of utilizing a listings database to obtain such information, and the application thereof within the context of the present invention will be readily apparent to those of such a skill level in light of this specification.

In some embodiments, the map data provides a map at a requested level of detail. The map can be displayed at various levels level of detail, and is typically at a relatively low level of detail such that the user can see streets and other features in the immediate vicinity of the destination. A user can also request to change the level of detail of the displayed map (e.g., zoom-in or zoom-out) or the orientation of the displayed map. As the displayed map is updated, the mapping system updates the displayed symbolic context information to provide context for the mapped location at the displayed level of detail. Of course, these examples simply represent the types of contexts in which the displayed symbolic context information is updated in conjunction with the updating of the displayed map.

The processing of the map data and the context data into a map and symbolic context information with a metadata description of their geographic relationship can be performed at any location in the system, or distributed between multiple components therein. For example, the application server can receive the map and context data from the map server in a format that either is or is not ready to display. The application server can transmit the map and/or context data to the mobile device in a raw format to be further processed by software on the mobile device, or in the form of a map and/or and symbolic context information ready to be displayed.

In some embodiments, a user can select specific displayed symbolic context information (e.g., a highway displayed on the perimeter of the map), and request a map that includes or provides a map to or from the corresponding location (i.e., the location of the highway). In response, the mapping system requests and receives corresponding data and displays a map of that location. The mapping system simultaneously displays symbolic context information with the display of the map.

### Figures

The following figures illustrate some of the features of the mapping system described above.

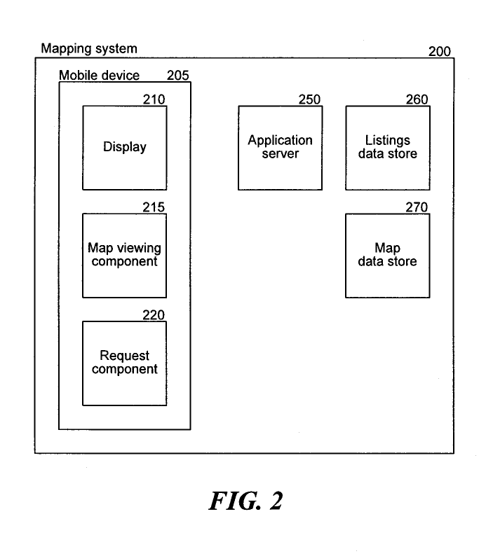

FIG. 2 is a block diagram that illustrates components of the mapping system in one embodiment. The mapping system 200 contains mobile device 205, an application server 250, a listings data store 260, and a map data store 270. The mobile device 205 may be a cell phone, personal digital assistant, in-car navigation system, portable tablet, laptop computer, touch screen computing device, or other types of computing devices with a limited viewing area, such as a smart appliance. The mobile device 205 contains a display 210, a map-viewing component 215, and a request component 220. The display 210 provides a user interface for interacting with a user. The map viewing component 215 displays maps on the display 210, along with symbolic context information as described herein. The map-viewing component 215 uses the request component 220 to send requests to a source of map data, such as application server 250. The application server 250 may be a website on the Internet or other source of map data. The application server 250 retrieves map data from a map data store 270, and symbolic context information from a listings data store 260. In some embodiments, the mobile device 205 may cache map data received during earlier communication with the application server 250, such that a dynamic connection with the application server 250 is not required to view maps and symbolic context information as described herein.

The computing device on which the system is implemented may include a central processing unit, memory, input devices (e.g., keyboard and pointing devices), output devices (e.g., display devices), and storage devices (e.g., disk drives). The memory and storage devices are computer-readable media that may be encoded with computer-executable instructions that implement the system, which means a computer-readable medium that contains the instructions. In addition, the data structures and message structures may be stored or transmitted via a data transmission medium, such as a signal on a communication link. Various communication links may be used, such as the Internet, a local area network, a wide area network, a point-to-point dial-up connection, a cell phone network, and so on.

Embodiments of the system may be implemented in various operating environments that include personal computers, server computers, handheld or laptop devices, multiprocessor systems, microprocessor-based systems, programmable consumer electronics, digital cameras, network PCs, minicomputers, mainframe computers, distributed computing environments that include any of the above systems or devices, and so on. The computer systems may be cell phones, personal digital assistants, smart phones, personal computers, programmable consumer electronics, digital cameras, and so on.

The system may be described in the general context of computer-executable instructions, such as program modules, executed by one or more computers or other devices. Generally, program modules include routines, programs, objects, components, data structures, and so on that perform particular tasks or implement particular abstract data types. Typically, the functionality of the program modules may be combined or distributed as desired in various embodiments.

FIG. 3 illustrates the simultaneous display of a map and symbolic context information concerning the mapped location, according to one embodiment of the present invention. The display 300 contains a map 310 and peripheral symbolic context information 320 and 330. The map 310 contains information about nearby streets, the user's destination, the zoom level, and so forth. The symbolic context information 320 indicates that there is a nearby highway running north and south. The symbolic context information 330 indicates that there is another nearby highway running east and west. Although the highways are not visible in the current map 310, the symbolic context information 320 and 330 provides the user with useful information if, for example, the user is trying to get somewhere else from the displayed map or if the user is trying to gain context about the displayed map 310.

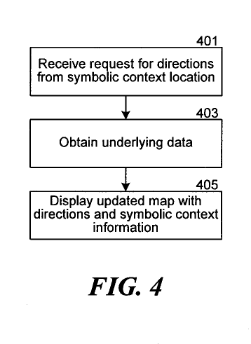

FIG. 4 is a flow diagram illustrating the processing of the mapping system to display directions from a location with related symbolic context information, according to some embodiments of the present invention. In step 401, the mapping system receives a request for directions to a location having symbolic context information. In step 403, the mapping system requests the underlying map and context data, such as from an application server or a storage device of the mobile device from which the mapping system is being used. In step 405, the mapping system displays the received map data and context data as a map with associated symbolic context information (e.g., a highlighted route).

### CONCLUSION

From the foregoing, it will be appreciated that specific embodiments of the mapping system have been described herein for purposes of illustration, but that various modifications may be made without deviating from the spirit and scope of the invention. Accordingly, the invention is not limited except as by the appended claims.

I/We claim:

1. A computer implemented method for displaying a map of a location on a portable display device, the method comprising:
requesting a map of a location;
receiving map data and context data responsive to the request;
displaying a map of the location based on the received map data; and
simultaneously displaying symbolic context information concerning the location based on the received context data, the displayed symbolic context information being a symbolic representation of one or more map entities that are geographically related to but not geographically within the displayed map, such that if a person navigates in the direction of the displayed symbolic context information, the person will encounter the physical items represented by the symbolic context information.

2. The method of claim 1 wherein displaying symbolic context information concerning the location further comprises displaying symbolic context information on the periphery of the map.

3. The method of claim 1 wherein displaying symbolic context information concerning the location further comprises displaying symbolic context information as an overlay to the map.

4. The method of claim 1 wherein displaying symbolic context information concerning the location further comprises performing a step from a group of steps consisting of:
displaying symbolic context information on the map in a distinct visual style; and
displaying a visual symbolic relationship between the location and the symbolic content, analogous to their geographic relationship.

5. The method of claim 1 wherein displaying symbolic context information concerning the location further comprises displaying at least one item of at least one type from a group consisting of: an icon, graphical data, and textual data.

6. The method of claim 1 further comprising:
receiving an indication from a user to map selected displayed symbolic context information; and
responsive to the indication, displaying a map of a location represented by the selected symbolic context information, and simultaneously displaying symbolic context information concerning that location.

7. The method of claim 1 further comprising:
receiving a request from a user to change the level of detail of the displayed map;
responsive to the request, displaying a map of a location at a changed level of detail, and displaying updated symbolic context information concerning the updated displayed map.

8. The method of claim 1 further comprising:
receiving an indication from a user to provide directions to the mapped location from a location represented by selected displayed symbolic context information; and
responsive to the indication, performing at least one step from a group of steps consisting of:
displaying directions to the mapped location from the location represented by the selected symbolic context information; and
displaying a route overlay to the mapped location from the location represented by the selected symbolic context information.

9. The method of claim 1 wherein the steps are performed by a mobile computing device.

10. The method of claim 9 wherein steps are performed by a mobile computing device selected from a group consisting of: a mobile phone, a personal digital assistant, an in-car navigation device, a tablet computing device, and a touch screen computing device.

11. A computer system for displaying a map of a location on a screen, the system comprising:
a computing device with a screen;
a component configured to request a map of a location;
a component configured to receive map data and context data responsive to the request;
a component configured to display a map of the location based on the received map data; and
a component configured to simultaneously display symbolic context information related to the location based on the received context data, the displayed symbolic context information being a symbolic representation of one or more points of interest that are not geographically within the displayed map but are geographically related to the displayed map.

12. The system of claim 11 wherein the component configured to display symbolic context information related to the location is further configured to display symbolic context information on the periphery of the map.

13. The system of claim 11 wherein the component configured to display symbolic context information related to the location is further configured to display symbolic context information as an overlay to the map.

14. The system of claim 11 wherein the component configured to display symbolic context information related to the location is further configured to display symbolic context information on the map in a distinct visual style.

15. The system of claim 11 further comprising:
a component configured to receive an indication from a user to map selected displayed symbolic context information; and
a component configured to display a map of a location represented by the selected symbolic context information, and to simultaneously display symbolic context information concerning that location, responsive to the indication.

16. A computer-readable medium encoded with instructions for controlling a computer system to display a map of a location for viewing using a limited viewing area, by a method comprising:
requesting a map of a location;
receiving map data and context data responsive to the request;
displaying a map of the location based on the received map data; and
simultaneously displaying symbolic context information concerning the location based on the received context data, the displayed symbolic context information being a symbolic representation of one or more map entities that are not geographically within the displayed map but are geographically nearby the displayed map.

17. The computer-readable medium of claim 16 wherein displaying symbolic context information concerning the location further comprises displaying symbolic context information on the periphery of the map.

18. The computer-readable medium of claim 16 wherein displaying symbolic context information concerning the location further comprises displaying symbolic context information as an overlay to the map.

19. The computer-readable medium of claim 16 wherein displaying symbolic context information concerning the location further comprises displaying symbolic context information on the map in a distinct visual style.

20. The computer-readable medium of claim 16 further comprising:
receiving an indication from a user to provide directions to the mapped location from a location represented by selected displayed symbolic context information;
responsive to the indication, displaying directions to the mapped location from the location represented by the selected symbolic context information; and
responsive to the indication, displaying a route overlay to the mapped location from the location represented by the selected symbolic context information.
